(19) United States
(12) Patent Application Publication
(10) Pub. No.: US 2025/0244076 A1
(43) Pub. Date: Jul. 31, 2025

(54) Method For Operating A Plant For Drying Material To Be Dried By Means Of Superheated Steam

(71) Applicant: Christoph Muller

(72) Inventor: Christoph Muller

(21) Appl. No.: 19/111,149

(22) PCT Filed: Sep. 6, 2023
(86) PCT No.: PCT/EP2023/074492

§ 371 Date: Mar. 12, 2025

(51) Int. Cl. F26B 23/00; F26B 3/04; F26B 21/00; F26B 21/04; F26B 21/12

(52) U.S. Cl. CPC F26B 23/004; F26B 3/04; F26B 21/005; F26B 21/04; F26B 21/12; F26B 2200/02; F26B 2200/04

(57) ABSTRACT

A material drying plant using superheated steam includes a downwardly open chamber with an inlet for the material to be dried, an outlet for dried material to be dried, an inlet for superheated steam and an outlet for a vapour, a conveying system for introducing the material into the chamber, transporting the material in the chamber, during drying, and discharging the dried material from the chamber, a vapour compressor for compressing a first portion of the vapour recirculated from the chamber and a heat exchanger for transferring heat from the compressed first portion by condensing a volume flow of the compressed first portion supplied to the heat exchanger. A vapour atmosphere is formed in an upper region of the chamber, which vapour atmosphere floats on ambient air located in a lower region of the chamber, wherein a transition layer is formed between the upper region and the lower region.

The invention relates to a method for operating a plant for drying material to be dried by means of superheated steam and to a corresponding plant.

### PRIOR ART

Industrial material drying consumes between 12 and 25% of the total industrial energy demand in industrialized countries, whereby the process of drying is one of the most energy-intensive. Since drying is usually based on fossil energy sources, the CO₂ emissions are gigantically high. A reduction in the energy demand required for drying is therefore of essential importance with regard to CO₂ reduction.

In methods which are advantageous with regard to the energy demand, superheated steam is used for drying instead of hot air. In U.S. Pat. No. 5,711,086 (Heat-Win Limited), a device has been proposed for this purpose, in which moist material is conveyed continuously through an opening into a chamber, through the chamber and out of the chamber through an opening. An atmosphere of superheated steam prevails in the chamber, which atmosphere arises from the moisture of the material to be dried and/or is supplied from the outside. In this case, a transition layer is formed between the vapour atmosphere and the surroundings in the openings and in a venting duct, which layer prevents escape of steam from the chamber but at the same time permits the material supply and removal.

The system therefore permits simple supply and removal of the material. The excess steam is condensed. By keeping the material mass flow, the residence time, the superheated steam mass flow and the temperature thereof constant, a constant dry substance content can be achieved in a simple manner. However, on account of the condensation of the excess steam and the return of the correspondingly removed heat by means of reheating, an energy loss results.

WO 2012/140125 A1 (Epcon Evaporation Technology) describes a method with a closed chamber, in which a mixing system is arranged, in which the moist material is contacted with superheated steam. The excess steam is mechanically compressed and supplied to a heat exchanger, with the result that energy recovery and therefore higher efficiency are possible.

Process control is likewise ensured on account of the closed chamber. However, challenges arise here in the material supply and removal.

### SUMMARY OF THE INVENTION

The object of the invention is to provide a method belonging to the technical field mentioned at the outset for operating a plant for drying material to be dried by means of superheated steam and a corresponding plant which permit high energy efficiency with simple material supply and removal.

The solution of the object is defined by the features of claim 1. According to the invention, for drying material to be dried with superheated steam, a plant is operated which comprises:
a) a downwardly open chamber with an inlet for the material to be dried, an outlet for dried material to be dried, an inlet for superheated steam and an outlet for a vapour;
b) a conveying system for introducing the material to be dried into the chamber, transporting the material to be dried in the chamber, during drying, and discharging the dried material from the chamber;
c) a vapour compressor for compressing a first portion of the vapour recirculated from the chamber;
d) a heat exchanger for transferring heat from the compressed first portion by condensing a volume flow of the compressed first portion.

This plant is operated in such a way that
e) a vapour atmosphere is formed in an upper region of the chamber, which vapour atmosphere floats on ambient air located in a lower region of the chamber, wherein a transition layer (stratification layer) is formed between the upper region and the lower region, and
f) a height of the transition layer is kept in a predetermined range by determining a current height and, depending on the determined height,
   f1) the volume flow of the compressed first portion supplied to the heat exchanger is regulated; or
   f2) a volume flow of a steam generator is regulated, wherein the steam generator is arranged and can be operated in such a way that steam is supplied to the chamber and/or is generated in the chamber.

Correspondingly, a plant according to the invention for drying material to be dried by means of superheated steam comprises:
a) a downwardly open chamber with an inlet for the material to be dried, an outlet for dried material to be dried, an inlet for superheated steam and an outlet for a vapour;
b) a conveying system for introducing the material to be dried into the chamber, transporting the material to be dried in the chamber, during drying, and discharging the dried material from the chamber;
c) a vapour compressor for compressing a first portion of the vapour recirculated from the chamber;
d) a heat exchanger for transferring heat from the compressed first portion by condensing a volume flow of the compressed first portion; and
e) a controller for acquiring and processing measured values and for generating control signals.

In this case, the controller is operated in particular in such a way that
f) an atmosphere of superheated steam is formed in an upper region of the chamber, which atmosphere floats on ambient air located in a lower region of the chamber, wherein a transition layer is formed between the upper region and the lower region, and
g) a height of the transition layer is kept in a predetermined range by determining a current height of the transition layer and, depending on the determined height,
   g1) the volume flow of the compressed first portion supplied to the heat exchanger is regulated; or
   g2) a volume flow of a steam generator is regulated, wherein the steam generator is arranged and can be operated in such a way that steam is supplied to the chamber and/or is generated in the chamber.

The material to be dried is in particular bulk material, for example products or by-products of the food or feed industry, combustible or building materials, basic substances for the chemical industry or the paper industry and biomass in general. The technology can also be used in connection with the drying of textiles (including laundry). In principle, the method is best suited for drying materials which require a drying temperature between 100° C. and 200° C. and do not allow additional organic substances to be gasified.

The steam is in particular water vapour, but other solvents can also be used, for example ethanol.

On account of the absence of oxygen during drying, oxidation of the material to be dried is avoided. Thus, for example, fats in food or animal feed do not turn rancid. In addition, the risk of fire and explosion is also minimized.

A loss of aroma is minimized by the circulation process. Odor and dust emissions to the surroundings do not occur. Since the temperature is consistently above 100° C., the material to be dried is pasteurized or even sterilized.

The chamber is closed at the top, while it is completely or partially open at the bottom. It can have one or more openings at the lower end, which openings are arranged on the main chamber boundary or on an inwardly or outwardly pointing, for example tubular, extension. Correspondingly, the main volume of the chamber can be completely filled with the vapour atmosphere, that is to say lie completely in the upper region of the chamber, and the transition layer can form in the tubular extension or in a plurality of tubular extensions. The opening or the openings are dimensioned in particular such that, on the one hand, pressure equalization and a certain gas flow between the chamber and the surroundings is possible and that, on the other hand, the introduction and discharge of the dried material through the opening or at least one of the openings is made possible. In particular, all the dried material is ultimately introduced into the chamber and discharged from the chamber through one or more such openings. The inlet for the material to be dried and the outlet for the dried material are therefore formed by one or more of these openings. Thus, material can be introduced and discharged in a cost-effective design, without significant amounts of air being transported into the steam in the process.

The vapour atmosphere contains a residual proportion of air; this is preferably less than 4% by volume.

The vapour is steam whose properties have been changed by the interaction with the material to be dried and the chamber atmosphere in relation to the superheated steam introduced. As a rule, the vapour will have a higher saturation and a lower temperature than the superheated steam introduced. In addition, the vapour can contain further constituents, in particular small amounts of material to be dried or dust, as an aerosol and also further vapours from the material, for example aromas.

The conveying system permits in particular continuous operation of the plant. In a preferred embodiment, it comprises an ascending conveyor for introducing the material to be dried through an opening on the chamber underside, a belt conveyor for transporting the material to be dried in the chamber and a gravitational removal through the same or preferably a further opening in the chamber underside. In an alternative embodiment, the conveying system comprises one rotor or a plurality of rotors, and the plant is operated as a disc dryer. Further conveying systems can be used within the scope of the invention, for example a fluidised bed or a paddle conveyor. The plant can also be used, for example, together with a spray drying tower. The conveying system can be formed in part by an upstream plant component, for example if the material to be dried is introduced into the vapour atmosphere directly by this component, for example an extruder, or is blown in via a vapour stream. The conveying system can comprise one or more conveyors (for example belts or gondolas). The chamber can itself be part of the conveying system—for example in the case of a paddle mixer. The introduction, the transport in the chamber and/or the discharge can be effected in each case completely or partially on account of gravity. Thus, for example, the dried material can fall out through an opening lying at the bottom.

Within the scope of the method according to the invention, the height of the transition layer, that is to say a vertical position, is now kept in a predetermined range. This corresponds to keeping the volume of the vapour atmosphere in the chamber constant.

The current height can be determined directly or indirectly. Instead of the height, a quantity dependent thereon can also serve as a control variable for the regulation of the volume flow of the compressed first portion supplied to the heat exchanger or of the steam generator, for example a temperature measured at a certain point or a plurality of points and/or the content of any gas contained in the air, for example O₂ or N₂, at a certain point or at a plurality of points.

In a first variant, the volume flow of the compressed first portion supplied to the heat exchanger is preferably set by regulating the volume flow of the vapour compressor. This can be done by setting the rotational speed of the vapour compressor and/or the opening of a regulatable orifice arranged upstream or downstream of the vapour compressor. Alternatively, a regulatable valve can be arranged downstream of the vapour compressor, a (proportional) volume flow of the compressed vapour being supplied to the heat exchanger, while the (possible) remainder is recirculated into the chamber. This alternative variant can be used, for example, in connection with turbocompressors which are ideally operated with a certain constant volume flow. In principle, such a (bypass) valve can also be arranged downstream of the heat exchanger, in which case the entire compressed first portion is guided through the heat exchanger, but only a part is condensed there, while the remaining remainder is recirculated into the chamber through the bypass valve. A combination of the variants is also conceivable, in particular the regulation being effected up to a certain minimum volume flow by regulating the vapour compressor, and the regulating valve being used only when the compressed portion supplied to the heat exchanger has to be reduced further.

In the first variant, the regulation is effected, in particular, in such a way that the volume flow of the compressed first portion supplied to the heat exchanger is increased when a fall of the transition layer is detected, and that the volume flow is reduced when an increase in the transition layer is detected. As a result, the volume flow of the first portion is ultimately set for increasing or reducing the discharged portion and thus the volume of the vapour atmosphere in the chamber.

In the first variant, the regulation of the volume flow of the compressed first portion supplied to the heat exchanger is thus preferably effected according to one of the following methods (wherein these methods can in principle also be combined with one another):
1. The height of the transition layer is regulated by setting the rotational speed of the vapour compressor. By increasing the rotational speed, the first portion to be compressed of the vapour recirculated from the chamber is increased, that is to say a larger portion is compressed and subsequently supplied to the heat exchanger as volume flow.
2. The height of the transition layer is regulated by a volume flow returned to the chamber from the first compressed portion. For this purpose, the opening of a (bypass) valve downstream of the vapour compressor is regulated in such a way that the height of the transition layer remains in the desired range. If the (bypass) valve is opened to a greater extent, the volume flow returned to the chamber rises, and correspondingly a smaller volume flow is available for condensation in the heat exchanger.
3. The height of the transition layer is regulated by setting the opening of an orifice upstream or downstream of the vapour compressor. Thus, the first portion to be compressed of the vapour recirculated from the chamber can be regulated while the rotational speed of the vapour compressor remains the same.

In a second variant, the regulation is effected, in particular, in such a way that the volume flow of the steam generator is reduced when a fall of the transition layer is detected, and that the volume flow of the steam generator is increased when an increase in the transition layer is detected. As a result, the volume of the vapour atmosphere in the chamber is ultimately influenced directly.

The return of the process heat by compression and condensation in a heat exchanger permits higher efficiency, but leads to all relevant process parameters becoming dependent on one another, which leads to non-linear behavior of the system. This represents a challenge, particularly when operating a plant with an open chamber, since it must always be ensured that the transition layer between the vapour atmosphere and the surroundings remains stable and within a permissible height range. The operation according to the invention makes it possible to achieve a stable process with a constant dry substance fraction even in the case of an open chamber.

Specifically, the vapour compressor can be operated by means of electrical energy, which readily permits operation with renewable energy and thus, compared with conventional drying methods, a massive reduction in the CO₂ emission.

Preferably, the current height of the transition layer is determined on the basis of measured values of at least one temperature sensor which is arranged in a height range corresponding to the predetermined range.

The at least one temperature sensor is preferably arranged in a pipe which extends downwards from the main volume of the chamber, in particular in the vertical direction, and connects the chamber to the surroundings. Alternatively or additionally, the temperature sensor can also be arranged in the opening for discharging the dried material to be dried.

The temperature sensor or the temperature sensors function as vapour filling level sensors and ultimately determine the height of the vapour-air transition layer (or a parameter directly connected thereto). In a preferred embodiment, a fall of the transition layer is assumed when a specific temperature sensor delivers a value which exceeds a first threshold value, while an increase in the transition layer is assumed when the specific temperature sensor delivers a value which falls below a second threshold value. The threshold values are selected in particular in the range of 90-100° C. and preferably differ by 2-8° C. Particularly preferably, the first threshold value is approximately 98° C., while the second threshold value is approximately 96° C.

Temperature sensors can be arranged in the region of the inlet and/or of the outlet. An arrangement below the chamber, in particular in the region of the outlet, is preferred here because disturbing influences of the dried material on the temperature measurement are generally smaller there than disturbing influences of the material to be dried at the inlet. The influences can be reduced further when the temperature sensors are arranged in a pipe, which is separate from the outlet, in the vicinity of the outlet. It has been found that a pipe with a diameter of 1.5-6 cm is sufficient for this purpose. Particularly preferably, temperature sensors are arranged both at the inlet and at the outlet. Thus, the best possible monitoring of the process and early detection of malfunctions are possible.

The control of the system parameters, in particular the rotational speed of the vapour compressor, on the basis of the measured temperature values is advantageously carried out by PID regulation, wherein the measured temperature values of a plurality of temperature sensors arranged at different heights and thus in particular also temperature gradients can be used. The controller can be integrated into a conventional machine controller (PLC) or can be implemented by the latter.

If a different solvent is used instead of water, different temperature values result. The prevailing air pressure also has an influence, in particular on account of the height above the sea level, which is to be taken into account when setting the temperature values. The above statements relate to carrying out the drying method at sea level.

Instead of the temperature sensor or the temperature sensors or in addition thereto, other measured values can be used for determining the height of the transition layer, for example one or more lambda probes for determining the oxygen content or a chemical sensor for determining the nitrogen content or the content of another gas contained in the air.

Advantageously, within the scope of the method according to the invention, a drying temperature is kept in a predetermined range by comparing it with a setpoint value and, depending on the comparison:
g1) a volume flow of a steam generator is regulated, wherein the steam generator is arranged and can be operated in such a way that steam can be supplied to the chamber or can be generated in the chamber, provided that the height of the transition layer is kept in the predetermined range by regulating the volume flow of the compressed first portion supplied to the heat exchanger; or
g2) a heating power of a heating device is regulated; or
g3) the volume flow of the compressed first portion supplied to the heat exchanger is regulated, provided that the height of the transition layer is kept in the predetermined range by regulating the volume flow of the steam generator.

The following variants thus result for the regulation of the height of the transition layer and the drying temperature:

| | regulation of the height of the | regulation of the drying |
|---|---|---|
| variant | transition layer | temperature |
| 1A | compressed portion to the heat | steam generator |
| | exchanger | |
| 1B | compressed portion to the heat | heating device |
| | exchanger | |
| 2A | steam generator | heating device |
| 2B | steam generator | compressed portion to |
| | | the heat exchanger |

In variant 2A, according to which the drying temperature is regulated by the heating power of the heating device and the transition layer is regulated by the steam generator, the vapour compressor has the task of extracting a first portion of vapour from the chamber, which is greater than in variant 1B, but less than in variant 2B. The vapour compressor therefore ensures that a higher temperature is achieved in the heat exchanger than in variant 1B and therefore the heating power of the heating device can be reduced.

The drying temperature is in particular the temperature of the superheated steam introduced into the chamber or—specifically in the case of indirect drying—the temperature of a contact surface with the material to be dried. The corresponding setpoint value depends in particular on the material and the desired dry substance content.

The dry substance content of the processed material to be dried can be determined in the chamber, for example by a temperature measurement of the surface of the material to be dried. Infrared temperature sensors are well suited for this purpose. On the basis of the measured surface temperature, the dry substance fraction can be inferred via a previously empirically determined characteristic curve. If this does not correspond to the specifications, system parameters are adapted, in particular the setpoint drying temperature of the superheated steam or of the contact surface in the case of indirect drying and/or the conveying speed of the conveying system (and thus the dwell time of the material to be dried in the chamber).

In a preferred embodiment, the plant comprises a pipe system between the outlet for the vapour and the inlet for the superheated steam, wherein the following is arranged in the pipe system:
g) the vapour compressor;
h) a circulating fan;
i) the heat exchanger for heating a second portion of the vapour recirculated from the chamber by transferring heat from the compressed first portion by condensing the volume flow of the compressed first portion supplied to the heat exchanger; and
j) a heating device for the steam, arranged between the heat exchanger and the inlet for the superheated steam.

The heat transfer in the heat exchanger is effected, in particular, in counterflow, wherein the compressed steam flow runs from top to bottom.

The circulating fan can be arranged upstream or downstream of the heat exchanger. It serves to maintain the steam flow in the circuit and thus to compensate for the pressure drop suffered. It has been found that the required mass flow increases approximately linearly with the evaporation rate. The mass flow to be delivered by the circulating fan should be at least 60 times the compressed mass portion supplied to the heat exchanger. It is thus ensured that, in addition to the actual evaporation of the liquid from the material to be dried, heat losses are also compensated for and the material to be dried together with the water contained and surface water located thereon can be preheated. The mass flow is preferably set to be higher than 60:1, with the result that a safety margin is provided, since the dissipation to be expected on account of the high mass flow passes into system-internal heat and thus contributes to the heating of the steam. Depending on the specific configuration of the plant, higher ratios of 100:1, 150:1 or even higher must be set. The circulating fan thus supports the heating device and can even replace the latter in certain embodiments.

The vapor compressor is a mechanical compressor. It serves for heat recovery. The vapour is supplied via parts of the pipe system or directly from the chamber. The vapor compressor can be of multistage design, i.e. by a plurality of compressor stages arranged in series.

The volume flow of the first portion of the vapour supplied to the heat exchanger and compressed by the vapor compressor is, in particular, proportional to the amount of steam which was released during the drying of the material, in such a way that a constant mass flow results in the circuit. The first portion results from the pressure ratio and the rotational speed of the vapor compressor according to the compressor characteristic map. The first portion can thus be set by regulating the rotational speed. The volume flow of the compressed first portion supplied to the heat exchanger is, as a rule, between 1:30 and 1:160, in each case based on the circuit steam.

Further heat sources, for example waste heat or dedicated heating devices, are possible in the heat exchanger in addition to the condensation of the compressed vapour (and possibly of steam from the steam generator).

The heating device for the steam is independent of the heat exchanger. It is in particular an electrical resistance heater. Alternatively, for example, a gas burner can also be used. As mentioned, the heating device can be integrated into the circulating fan; in particular, the heating of the steam is effected on account of dissipation in the fan. If it is separate from the fan, it is arranged downstream of the fan in the circulation direction, preferably directly upstream of the inlet into the chamber. The desired dry substance fraction can ultimately be set by means of regulation of the heating device. Instead of a resistance heater (or in addition thereto), waste heat can be used in the heating device, for example of exhaust gases from gas engines, said waste heat being released to the steam via a regulatable heat exchanger (for example gas-gas heat exchanger for using hot gas waste heat).

The heating device can comprise one or more heating units. For example, in the case of a belt dryer, each belt is assigned a separate heating unit. Accordingly, the operation of individual heating units can be regulated separately or centrally.

Ultimately, a constant dry substance content is desired. In the event of a change in the vapour compression rate for setting the height of the transition layer, the condensation temperature in the condenser is changed in the medium term and therefore also the evaporation rate in the material is influenced, which in turn leads to a change in the steam level. This effect can be compensated for by the regulation of the heating power.

Although hardly any air passes into the system through the open locks, trace amounts can never be completely ruled out. The small proportions of air in the system are concentrated in the condenser and block valuable heat transfer surface over time. In order to avoid this, the condenser has to be deaerated continuously. Advantageously, the heat exchanger therefore has a venting valve on the condenser side, and an opening of the venting valve is regulated on the basis of a determined air content on the condenser side. The air content can be determined on the basis of the condensor pressure and the condensation temperature, on the basis of the deviation from the saturation temperature or directly by means of a lambda probe.

The venting valve is arranged in particular as a needle valve, advantageously above the condensate outlet. The latter permits the discharge of excess condensed water. Advantageously, it is regulated on the basis of the measured values of one or more filling level sensors which can be formed, for example, by capacitive limit switches. Ultimately, the water is recovered from the material to be dried, usually in the sterile and demineralized state.

Advantageously, the air content on the condenser side is regulated to a value of 0-50%, preferably 5-20%, particularly preferably 7-12%. If a lower setpoint value is undershot, a substantial loss of steam results. If the value is too high, the efficiency of the vapor compression suffers.

Since the air mass flow conducted into the condenser is not constant and is highly dependent on the operating state of the plant, the venting valve has to be continuously readjusted. Thus, the air content in the condenser can be kept at the desired percentage.

In a preferred embodiment, a pipe departing from the condenser opens into a branch (e.g. a T-piece or Y-piece).

Thus, at the outlet of the condenser, water and non-condensable gases are reliably separated and it is achieved that a minimum of steam is lost to the surroundings. One leg of this branch leads into a horizontal or slightly upwardly directed discharge line which is provided with the venting valve. The other leg leads (in particular vertically) downwards into a pipe section with an enlarged cross section, in which a water column is formed. This permits regulated and delayed discharge of the condensed water.

Two (e.g. capacitive) filling level sensors are arranged along the pipe section with the water column. At the bottom, a shut-off valve is connected which is opened or closed as a function of the measured values of the filling level sensors such that the level of the water column is always located between the filling level sensors.

A throttle (e.g. a needle valve) is arranged downstream of the shut-off valve. This component ensures that the outflow of the condensed liquid proceeds more slowly and escape of gas/air mixture downwards is made impossible.

On account of the pressure drop across the shut-off valve with a downstream throttle, steam is generated, and the condensate outlet thus forms a (further) steam generator. This steam can be fed back into the steam circuit, the drying chamber and/or the material to be dried via the corresponding pipe and can be used for further drying and/or preheating of the material.

In this preferred embodiment, too, the venting valve is regulated on the basis of the determined air content on the condenser side which, as mentioned, can be determined directly, by means of a lambda probe, or indirectly on the basis of the deviation of the static pressure from the steam pressure of the condensation temperature.

Advantageously, the inlet for the superheated steam is arranged on the chamber in such a way that the superheated steam in a directed vapour flow intersects a conveying path of the material to be dried in the chamber. This is preferably effected in cross or counterflow. The supply and removal of the superheated steam and the internal geometry of the chamber are, in particular, coordinated with one another in such a way that a circuit takes place through the vapour atmosphere in the chamber.

In the case of an embodiment of the plant according to the invention as a belt dryer, it is advantageous if the inflow of the superheated steam and the extraction take place as close as possible to the material.

Preferably, an element for homogenizing the vapour flow is arranged on the chamber side of the inlet. In this case, the element forms, in particular, a flow resistance which calms the vapour flow, i.e. eliminates, in particular, large-scale vortices or secondary flows, and standardizes the flow profile. The resistance is dimensioned such that sufficient harmonization of the vapour flow is achieved, but an unnecessary pressure loss with associated increase in the required power of the circulating fan is avoided. The element can be designed in the manner of a filter or from finely perforated material. For example, glass fibre mats are suitable. Arranged upstream can be a diffuser which distributes the vapour flow over a larger cross section.

The circulation of the superheated steam in the chamber can be controlled by means of such an element. In addition, it has been found that the transition layer is stabilized as a result.

When the plant is started up, the required vapour atmosphere must first of all be formed in the upper region of the chamber. For this purpose, the plant preferably comprises a steam generator, and in particular the following steps are carried out:
generating steam in a steam generator and introducing the generated steam into the chamber, wherein air located in the chamber is displaced downwards out of the chamber;
   during the operation of the steam generator (after completion of the build-up of the vapour atmosphere or the displacement of the air out of the chamber) until an operating pressure is reached in the heat exchanger:
activating the circulating fan,
activating the heating device and/or the vapor compressor,
introducing material to be dried by means of the conveying system, and
activating the vapor compressor.

The generated steam is introduced, in particular, from above, preferably at the highest point of the chamber and/or of the pipe system. Beforehand, the chamber is preferably preheated to 100° C. with air. The air is displaced by the introduced steam not only out of the chamber but, in particular, also out of the pipe system.

During the last phase, in which both the steam generator and the vapor compressor are active, the operating pressure is built up in the heat exchanger operated as a condenser while maintaining the vapour atmosphere. This is, in particular, 1.5-4 bar over atmospheric pressure, depending on further machine and process parameters. When the operating pressure is reached, the steam generator is switched off and thus the transition to nominal operation takes place.

In a further embodiment of the invention, the conveying system has a rotating hollow shaft which is arranged in the chamber and has a plurality of discs and forms the heat exchanger, wherein a cavity is arranged in an interior of the hollow shaft, to which cavity the volume flow of the compressed first portion of the vapour can be supplied by the vapour compressor for heating the discs; in this embodiment, the first portion therefore corresponds to the entirety of the recirculated vapour, but, in a corresponding embodiment thereof, a portion thereof can be returned into the chamber by a (bypass) valve arranged downstream of the vapour compressor. The hollow shaft thus acts as a condenser for the recirculated, compressed vapour. The cavity can extend into the discs or be restricted to the central part of the hollow shaft.

The liquid material to be dried is supplied to the discs through an inlet, dried and finally, after drying, removed from the discs, for example scraped off, and discharged from the chamber through a material outlet. The drying is thus effected indirectly in this embodiment.

In the embodiment with the rotating disc shaft, steam from a steam generator is preferably supplied to the chamber. This supply is effected (also) during the drying process, in particular in a continuous manner, and, after compression of the steam by the vapour compressor and supply into the hollow shaft, ultimately serves for drying the liquid material and for heating the chamber and for compensating for losses.

The steam generator is arranged and is operated in such a way that steam can be supplied to the chamber or can be generated in the chamber. The supply can be effected directly into the chamber or indirectly, for example via a pipe system. The generation of steam is effected, for example, by injecting water into an atmosphere of superheated steam. Accordingly, the steam generator can also be arranged directly in the chamber.

In one embodiment of the invention, the volume flow of the compressed first portion supplied to the heat exchanger is in turn regulated on the basis of the current height of the transition layer. In this case, the volume flow of the steam generator is preferably regulated on the basis of a measured condensation temperature in the cavity of the hollow shaft in such a way that this condensation temperature remains in a predetermined interval. As a result, the dry substance fraction of the material to be dried is ultimately set. This corresponds to the variant 1A illustrated above.

In a further regulating method, which is likewise suitable for the variant with the rotating disc shaft, the height of the transition layer is kept in the predetermined range not by regulating the volume flow of the compressed first portion supplied to the heat exchanger, but by regulating the volume flow of the steam generator. In this alternative method, the volume flow of the compressed first portion supplied to the heat exchanger is regulated, in particular on the basis of the measured condensation temperature in the cavity, in such a way that this condensation temperature remains in a predetermined range. This corresponds to the variant 2B illustrated above.

In all embodiments of the invention, a steam generator arranged in the plant can be operated by waste heat. In this case, condensate from the heat exchanger can serve, in particular, as feed water. If the condensate is not sufficient for feeding, a further water supply, for example from a tank, can be provided.

In plants with a steam circuit, steam from such a steam generator can be introduced into the circuit, so that the compressed first portion supplied to the heat exchanger can be increased. This results in a higher condensation temperature and therefore an increased quantity of heat which is output to the circuit flow via the heat exchanger. Accordingly, the power of the heating device can be reduced, which can lead to increased process efficiency.

Further advantageous embodiments and combinations of features of the invention result from the following detailed description and the entirety of the claims.

### BRIEF DESCRIPTION OF THE DRAWINGS

The drawings used to explain the exemplary embodiment show:

FIG. 1A, B Schematic block diagrams of a plant according to the invention for drying material to be dried by means of superheated steam according to a first embodiment and a second embodiment, respectively;

FIG. 2A a schematic sectional view of the plant according to the first embodiment;

FIG. 2B a detailed view of an advantageous embodiment of the condensate outlet for the plant according to the first embodiment;

FIG. 3 a schematic sectional view of the plant according to a third embodiment;

FIG. 4A, B schematic sectional views of a drying chamber of a plant according to the invention according to a fourth embodiment;

FIG. 5A, B schematic sectional views of a drying chamber of a plant according to the invention according to a fifth embodiment;

FIG. 6 an illustration of the actuators and controlled variables of the plant according to the invention;

FIG. 7 a block diagram of the sensor system of the plant according to the invention according to the first embodiment;

FIG. 8 profiles of the measured temperature at three heights in a vertical pipe next to the outlet; and

FIG. 9 profiles of the temperature and of the air content when the plant according to the invention is started up;

In principle, identical parts are provided with identical reference symbols in the figures.

### WAYS OF CARRYING OUT THE INVENTION

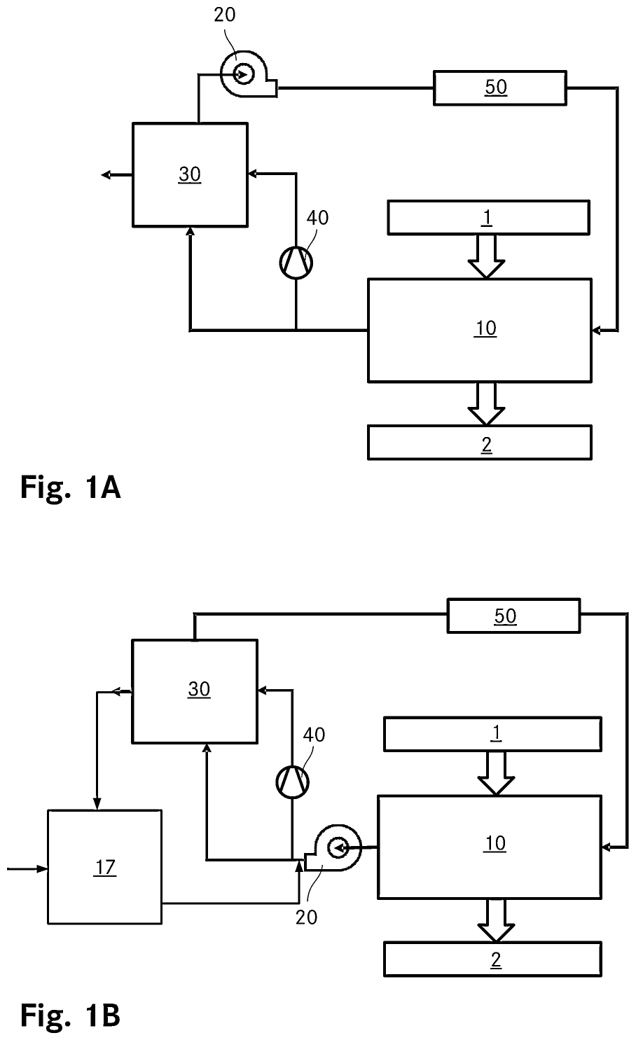

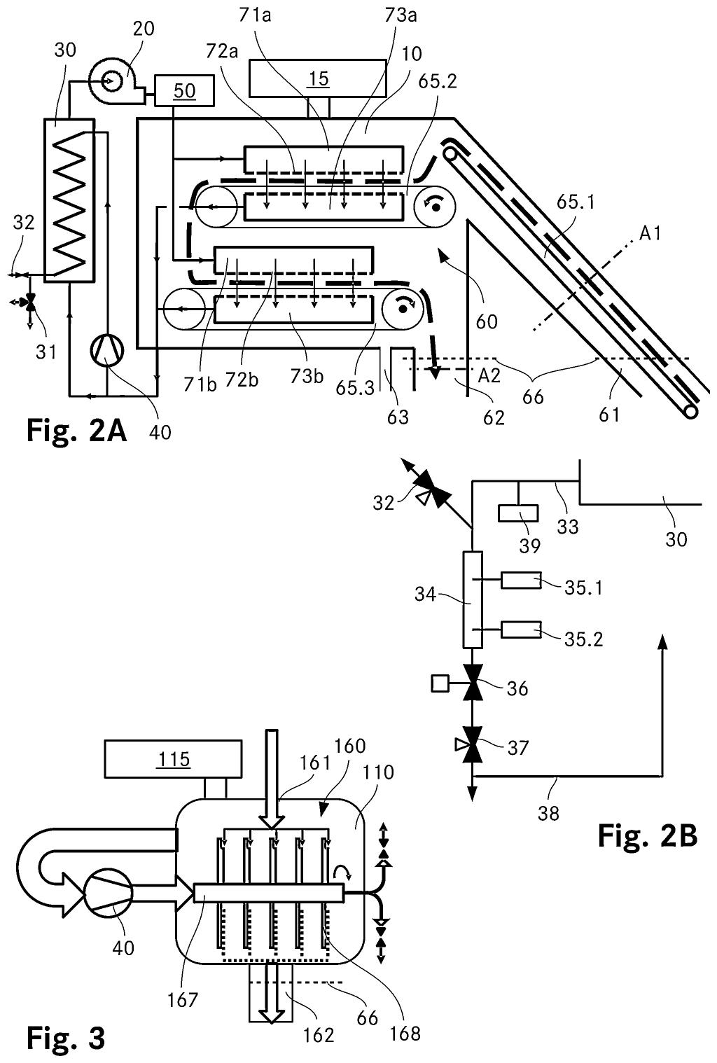

FIGS. 1A, B are schematic block diagrams of a plant according to the invention for drying material to be dried by means of superheated steam according to a first embodiment and a second embodiment, respectively. FIG. 2A shows a schematic sectional view of the plant according to the first embodiment. The first and the second embodiment differ in the positioning of the circulating fan in the steam circuit. In addition, the second embodiment comprises a further steam generator which can be operated with waste heat. It is to be taken into account that the use of such a steam generator is also possible when positioning the circulating fan as in the first embodiment. Otherwise, all the following statements apply both to the first and to the second embodiment.

The plant comprises a chamber 10, into which moist material 1 can be introduced and dried material 2 can be discharged by means of a conveying system 60. In the plant illustrated, the mass flow of the moist material 1 (dry substance fraction 50%, temperature 50-70° C.) is 36 kg/h. The chamber 10 is closed at the top and at the side and open at the bottom; in the exemplary embodiments illustrated, it correspondingly comprises
an inlet 61, which is designed as a pipe running obliquely upwards to an upper region of a side wall of the chamber 10 with a bucket conveyor 65.1 of the conveying system 60 arranged therein and acting as an ascending conveyor; the cross section A1 perpendicular to the longitudinal axis of the pipe is approximately 0.10 m²;
an outlet 62, which is designed as an opening on the underside of the chamber 10, through which the dried material 2 is discharged under the action of gravity; the cross section A2 of the opening is approximately 0.02 m²;
a downwardly open measuring tube 63 (cf. FIG. 2), which is arranged in the region of the outlet 62 and contains a plurality of temperature sensors.

The bucket conveyor 65.1 comprises trays for receiving the material to be dried, which trays are perforated so that air is not transported upwards at the transition into the chamber 10.

During operation, the chamber 10 is filled with water vapour, which floats above the ambient air.

A feed line of a steam generator 15 opens into the upper side of the chamber 10, so that steam can be supplied directly to the chamber 10 if required—in particular when starting up as described later. Steam discharge valves can likewise be arranged on the upper side of the chamber 10 in order to discharge excess steam from the chamber 10 (not illustrated).

The bucket conveyor 65.1 introduces the moist material 1 from the ambient air into the vapour atmosphere slowly from below, at a speed of 10-30 mm/s, without air being carried along.

Two horizontal belt conveyors 65.2, 65.3 are arranged in the chamber 10 in such a way that the first of these further belt conveyors 65.2 receives the moist material from the bucket conveyor 65.1, conveys it through a first drying stage and discharges it to the second of the belt conveyors 65.3, which conveys the material through a second drying stage. The area through which the steam flows in the region of the belt conveyors 65.2, 65.3 is in each case approximately 0.45 m². From the second belt conveyor 65.3, the material falls out of the chamber 10 through the outlet 62, through the vapour-air transition layer.

The residence time of the material in the chamber 10 is set by the conveying speed of the conveying system 60. In the plant illustrated, it is typically approximately 20-30 min.

A closed circuit steam duct is coupled to the chamber 10. The circuit is driven by a circulating fan 20. In the plant illustrated, the volume flow in the circuit is 2,150 m³/h.

The processed, superheated steam is divided into two partial flows on entry into the chamber. Each of the partial flows firstly passes a diffuser, in which it is distributed over a larger cross section, and then a filter element 72a, 72b. In the exemplary embodiment illustrated, these are designed as biaxially woven glass fibre mats with a basis weight of 610 g/m². This results in a pressure loss coefficient ζ of 400 at a steam flow rate of 1.3 m/s and a value for ζ of 200 at a steam flow rate of 7 m/s or more.

They serve for homogenizing the vapour flow. Subsequently, the vapour flows are output in divided form through a first steam inlet 71a adjacent to the first belt conveyor 65.2 and through a second steam inlet 71b adjacent to the second belt conveyor 65.3. In the plant illustrated, the evaporation mass flow is approximately 16 kg/h (corresponding to 26.7 m³/h of steam). The steam volume in the steam chamber is 0.85 m³, wherein the air content is lower than 4%.

The vapour flows cross the transport surfaces of the belt conveyors 65.2, 65.3 and are sucked out of the chamber 10 again in each case through a steam outlet 73a, 73b on the opposite side. The steam supplies heat to the material to be dried, as a result of which water evaporates. The dry substance fraction of the material is determined in this case by an analysis of the material after the outflow into the ambient air, on the basis of which the steam temperature and the residence time are readjusted. Alternatively, the dry substance fraction can also be checked by an (optical) temperature measurement of the material surface in the steam, wherein a plurality of corresponding sensors can be arranged along the conveying path in the chamber in order to monitor the drying process.

For the introduction of heat into the circulating steam duct, the latter contains a heat exchanger 30 and subsequently a heating device 50. The latter advantageously comprises a first heating unit 51a for that steam fraction which is supplied to the first steam inlet 71a and a second heating unit 51b, which can be regulated independently thereof, for that steam fraction which is supplied to the second steam inlet 71b.

The heat exchanger 30 is a lamellar heat exchanger. It has an outer heat exchanger area of approximately 95 m² and an inner heat exchanger area of approximately 2.3 m². A filter can be arranged upstream of the heat exchanger 30 in order to avoid its contamination by entrained material fractions. The heat exchanger 30 operates internally as a condenser by a vapor compressor 40 compressing a part of the steam sucked out of the chamber 10 and supplying it to the condenser, where it condenses under elevated pressure, typically 2.5-4 bar over atmospheric pressure, and in the process transfers the enthalpy of evaporation via the heat exchanger 30 to the circulating steam flow. In the exemplary embodiment illustrated, the vapor compressor 40 has an installed power of 3.7 kW. During operation, the power is usually approximately 1.1 kW.

The subsequent heating device 50 further superheats the circulating steam flow to the necessary drying temperature.

For discharging the water, the condenser of the heat exchanger 30 has a condensate discharge valve 31 which is opened automatically depending on the water level. For this purpose, the water level is monitored with one or more capacitive filling level sensors and the valve is opened for a predefined period of time when the water level exceeds a certain desired level. If two water level sensors are used, the upper sensor can serve for initiating the emptying process, while the predefined time interval is shortened when the lower water level sensor responds during the emptying. It is thus ensured that a condensate column always remains in the height range between the lower sensor and the valve, with the result that the vapour/air mixture cannot escape directly through the valve. In the plant illustrated, the mass flow of the condensate is typically approximately 7.5 kg/h (corresponding to 13.6 m³/h of steam).

In addition, an air discharge valve 32, through which non-condensable gases are discharged, is fitted above the water outlet. The fraction of these gases in the steam is determined by temperature and pressure sensors at the condenser outlet.

Within the scope of the second embodiment, the condensate from the heat exchanger 30 is supplied to a steam generator 17. Waste heat (for example with a temperature of approximately 170° C.) is supplied to said steam generator in order to evaporate the condensate. The generated steam is then supplied to the steam circuit downstream of the circulating fan 20 and upstream of the branch of the feed pipes to the heat exchanger 30 and to the vapor compressor 40.

FIG. 2B shows a detailed view of an advantageous embodiment of the condensate outlet for the plant according to the first embodiment. A pipe 33 departing from the condenser of the heat exchanger 30 opens into a Y-branch. One leg of this branch leads into a horizontal or slightly upwardly directed discharge line which is provided with the air discharge valve 32. The other leg leads vertically downwards into a pipe section 34 with an enlarged cross section, in which a water column is formed. Two (e.g. capacitive) filling level sensors 35.1, 35.2 are arranged along this pipe section 34 with the water column. At the bottom, a shut-off valve 36 is connected which is opened or closed as a function of the measured values of the filling level sensors 35.1, 35.2 such that the level of the water column is always located between the filling level sensors 35.1, 35.2.

A further pipe section and then a needle valve 37 as a throttle are connected to the shut-off valve 36. The steam generated on account of the pressure drop at the shut-off valve 36 and the needle valve 37 is ultimately fed back into the steam circuit, into the drying chamber and/or to the material to be dried via a pipe 38 arranged downstream of the needle valve 37.

In turn, the air discharge valve 32 is regulated on the basis of the air content on the condenser side, determined directly by means of a lambda probe 39 or indirectly on the basis of the deviation of the static pressure from the steam pressure of the condensation temperature.

FIG. 3 shows a schematic sectional view of the plant according to a third embodiment. The plant according to the third embodiment serves for indirect drying. It comprises a chamber 110 which is filled with steam, is closed at the top and is partially open at the bottom. The conveying system 160 in the chamber 110 has a rotating hollow shaft 167 with a plurality of discs 168, which hollow shaft is hollow and functions both for conveying the material and as a heat exchanger, that is to say acts as a condenser in the interior. The plant furthermore has a vapor compressor 40, a steam generator 115 and an inlet 161 for liquid material to be dried.

The liquid material to be dried is supplied to the outer side of the hollow shaft 167 with the discs 168 through the inlet 161. Vapour from the chamber 110 is supplied to the vapor compressor 40. For this purpose, the vapor compressor 40 sucks the vapour out of the chamber and, after the compression, feeds at least a portion into the hollow disc condenser. There, the compressed steam condenses and thus heats the hollow shaft 167 with the discs 168, as a result of which the material is dried. In this case, the dry substance fraction of the material to be dried is set via the condensation temperature. The air content in the hollow shaft 167, which acts as a condenser, is regulated to a predetermined content by a discharge valve. The dried material is scraped off from the discs 168 by a scraper which grinds on the hollow shaft 167 and discharged through an outlet 162 on the underside of the chamber 110. For constant heating of the plant and for compensating for losses, steam is continuously drawn from the steam generator 115. A steam blower is not required in the plant according to the third embodiment.

The plant according to the third embodiment can be regulated in two basic ways:
According to a first method, the volume flow of the steam generator 115 is regulated by measuring the condensation temperature of the hollow shaft in such a way that this temperature remains in a predetermined interval. The volume flow of the compressed portion supplied to the disc condenser is regulated on the basis of a temperature sensor in the region of the steam/air separation layer in such a way that this temperature remains in a predetermined range, whereby the transition layer remains at a predetermined height.
According to a second method, the volume flow of the compressed portion supplied to the disc condenser is regulated by measuring the condensation temperature of the hollow shaft in such a way that this temperature remains in a predetermined interval. The volume flow of the steam generator 115 is regulated on the basis of a temperature sensor in the region of the steam/air separation layer in such a way that this temperature remains in a predetermined range, whereby the transition layer remains at a predetermined height.

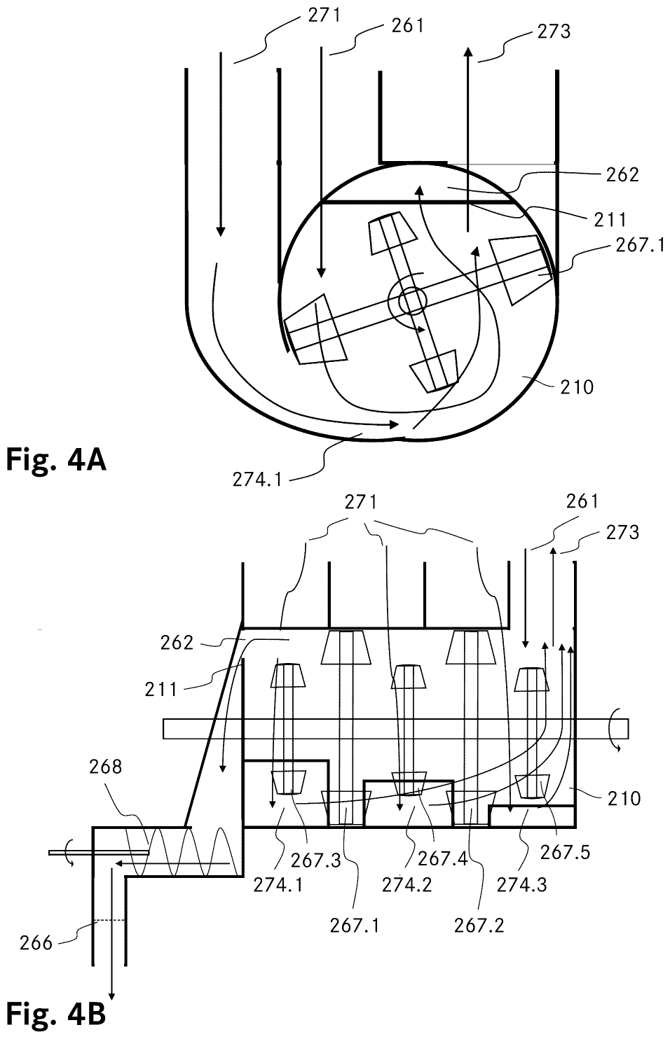

FIGS. 4A and 4B are schematic sectional views of a drying chamber of a plant according to the invention according to a fourth embodiment and of the corresponding supply and removal, wherein an ascending conveyor, which is formed analogously to that according to the first three embodiments and serves for introducing the material to be dried into the vapour atmosphere of the chamber, is not illustrated in the figures. FIG. 4A shows a view in a vertical plane perpendicular to the axis of rotation of the paddle, and FIG. 4B shows a view in a vertical plane which runs through this axis of rotation. The further components of the plant, in particular for steam supply and removal and treatment, for material supply, for the sensor system and controller, correspond substantially to those of one of the first three embodiments.

The chamber 210 forming a conveying duct has a substantially circular cylindrical shape. The paddles 267.1, 267.2 are mounted rotatably about the longitudinal axis of the chamber 210 and have a constant distance from the chamber wall. Said distance is to be selected to be so small depending on the conveyed material that jamming of the material is avoided. Paddles 267.3, 267.4, 267.5 with a larger wall distance are mounted adjacent to the paddles 267.1, 267.2 with a small wall distance, the mutual axial distance of the paddles 267.1 . . . 5 always being the same. Here, too, the gap dimension is to be selected to be so large depending on the conveyed material that relatively coarse pieces cannot be jammed, but the transport of material is promoted. The paddles 267.1 . . . 5 in each case have an axial setting angle in the conveying direction of e.g. 30°. A different number of paddles can also be used.

Two vertical channels open into the chamber 210 at one end on the upper side, one serves as inlet 261 for material to be dried and the other serves as outlet 273 for steam discharge. A lateral outlet 262 for discharging the dried material is arranged at the other end of the chamber 210 in the upper region. The height of the lower edge of the outlet 262 and thus the filling height of the conveying duct can be set by the vertical adjustment of a weir 211. A filling degree of ⅔ or more is desired.

The paddles 267.1 . . . 5 rotate slowly, at approximately 20-30 revolutions per minute. They can rotate in both directions, the main direction of rotation (for conveying the material in the direction of the material outlet) pointing in such a way that the paddles 267.1 . . . 5 move downwards where the steam enters.

The dried material falls through the outlet 262 into a conveying duct with a spiral 268 for the controlled back-up and for the controlled removal of the material. As soon as the material has passed the spiral 268, it falls into a vertical removal duct, in which the transition layer 266 runs between the surroundings and the vapour atmosphere. The controlled back-up ensures that the transition layer 266 is stable.

Steam is fed from above out of the steam circuit through corresponding inlets 271 and, distributed over the length of the conveying duct, is introduced laterally/horizontally into the mixer/conveying trough in the lower region of the chamber 210 via inlets 274.1 . . . 3. In this case, the flow resistance of the material lying thereon is used to generate a uniform inflow, whereby a drying process which is as homogeneous as possible is intended to be produced. At the same time, this design of the steam feed prevents material from falling back into the steam circuit.

The steam inflow is in this case set such that there is no inflow opening at the axial positions of the paddles 267.1, 267.2 with a small gap dimension. The gap is in each case as wide as the paddle tip. At the locations without or with a shortened paddle 267.3 . . . 5 with a large gap dimension, the steam is conducted into the chamber 211 via an inflow opening.

The lateral openings can be of different sizes. Depending on the required steam distribution along the mixer axis, they become smaller the closer they are to the material inlet or steam outlet. (Otherwise, the steam would select the path of the lowest flow resistance, whereby there would be no or little flow in a large part of the mixer.)

The steam temperature of the lateral inflow channels does not have to be uniform, but rather increases optimally along the conveying channel in the conveying direction. The dryer the material becomes towards the end of the process, the hotter the introduced steam.

The laterally inflowing steam flows through the loosened material first approximately transversely and then in counterflow to the material flow direction. Finally, the steam next to the inlet 261 for the material is sucked upwards through the outlet 273, as a result of which no particles are to be carried along.

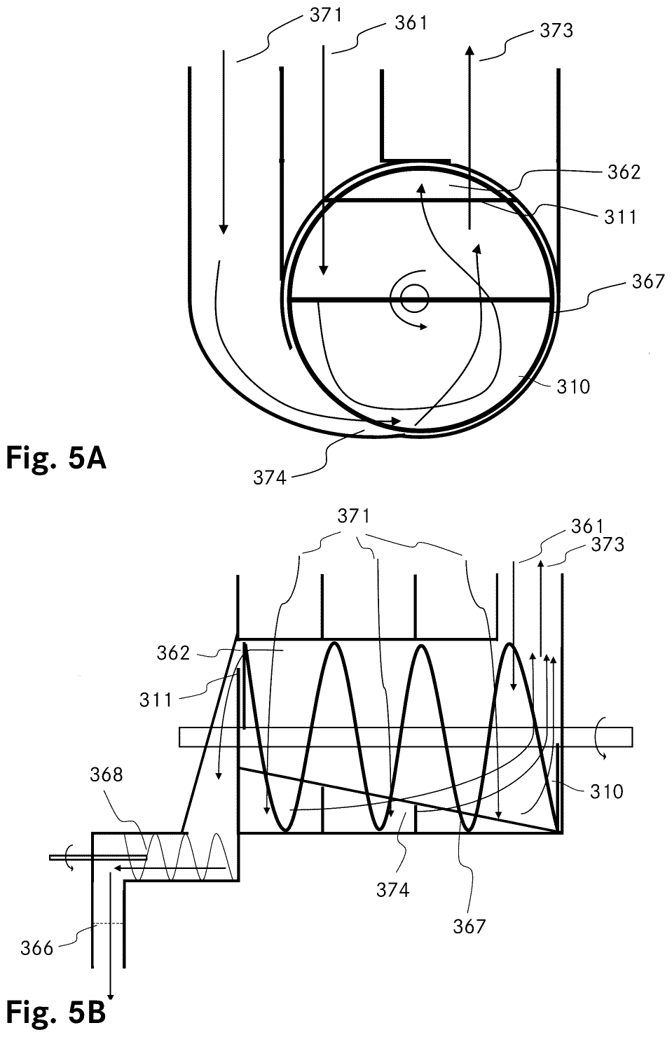

FIGS. 5A and 5B are schematic sectional views of a drying chamber of a plant according to the invention according to a fifth embodiment and of the corresponding supply and removal. FIG. 5A shows a view in a vertical plane perpendicular to the axis of rotation of the spiral, and FIG. 5B shows a view in a vertical plane which runs through this axis of rotation. The further components of the plant, in particular for steam supply and removal and treatment, for material supply, for the sensor system and controller, correspond substantially to those of one of the first three embodiments.

The drying chamber according to the fifth embodiment has many similarities with that of the fourth embodiment. The main difference is that, instead of paddles, a spiral is used as a mixing and conveying element in the chamber. The chamber 310 forming a conveying duct has a substantially circular cylindrical shape. The spiral 367 is mounted rotatably about the longitudinal axis of the chamber 310; the individual windings have a small distance from the chamber wall.

Two vertical channels open into the chamber 310 at one end on the upper side, one serves as inlet 361 for material to be dried and the other serves as outlet 373 for steam discharge. A lateral outlet 362 for discharging the dried material is arranged at the other end of the chamber 310 in the upper region. The height of the lower edge of the outlet 362 and thus the filling height of the conveying duct can be set by the vertical adjustment of a weir 311. A filling degree of ⅔ or more is desired. The spiral 367 rotates slowly, at approximately 20-30 revolutions per minute. It can rotate in both directions, the main direction of rotation (for conveying the material in the direction of the material outlet) pointing in such a way that the windings of the spiral 367 move downwards where the steam enters.

The dried material falls through the outlet 362 into a conveying duct with a spiral or a screw 368 for the controlled back-up and for the controlled removal of the material. As soon as the material has passed the spiral 368, it falls into a vertical removal duct, in which the transition layer 366 runs between the surroundings and the vapour atmosphere. The controlled back-up ensures that the transition layer 366 is stable.

Steam is fed from above out of the steam circuit through corresponding inlets 371 and, distributed over the length of the conveying duct, is introduced laterally/horizontally out of the conveying duct into the mixer/conveying trough in the lower region of the chamber 310 via an inlet 374. In this case, the flow resistance of the material lying thereon is used to generate a uniform inflow, whereby a drying process which is as homogeneous as possible is intended to be produced. At the same time, the design of the steam feed prevents material from falling back into the steam circuit. The cross section of the inlet 374 decreases counter to the material conveying direction. The inlet 374 is divided into different temperature zones in the feed, so that the steam temperature increases along the conveying duct in the conveying direction: the dryer the material becomes towards the end of the process, the hotter the introduced steam.

The laterally inflowing steam flows through the loosened material first approximately transversely and then in counterflow to the material flow direction. Finally, the steam next to the inlet 361 for the material is sucked upwards through the outlet 373, as a result of which no particles are to be carried along.

The operation of the plant according to the invention is described below with reference to the first two embodiments. However, the corresponding statements can readily also be transferred to the three further embodiments.

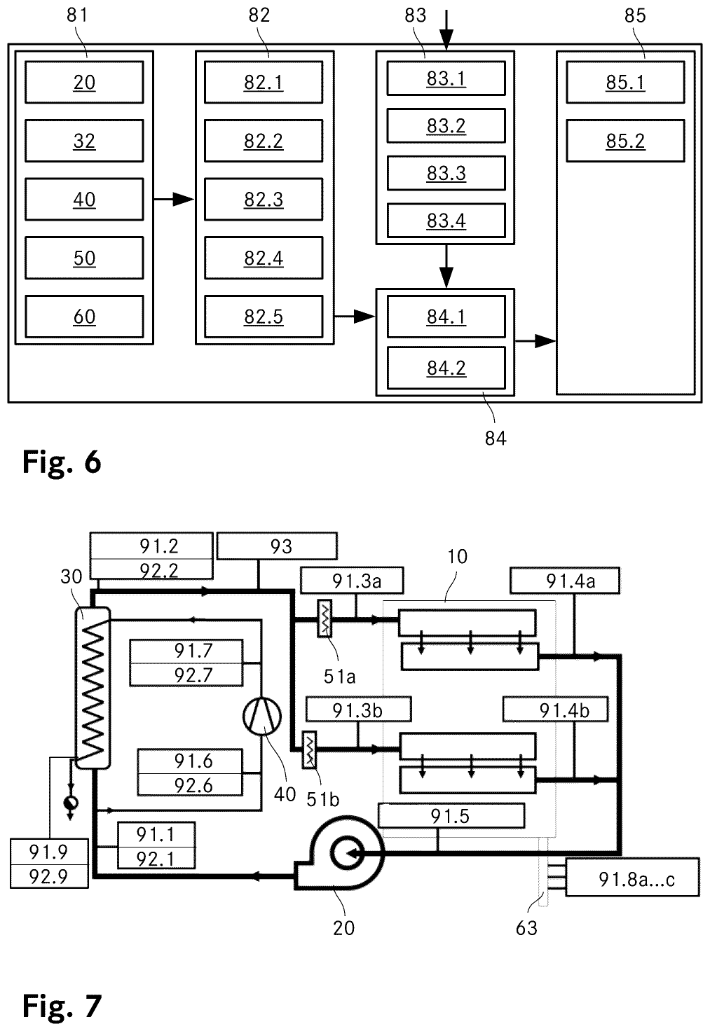

FIG. 6 is an illustration of the actuators and controlled variables of the plant according to the invention, namely of the plant according to the first embodiment, when it is operated according to variant 1B, wherein the volume flow of the compressed first portion supplied to the heat exchanger 30 is set by regulating the vapour compressor 40. The control variables 82 can be influenced by the actuators 81. The actuators 81 comprise the circulating fan 20, which can be regulated in particular via its rotational speed in order to set the circulating steam flow 82.3, the air discharge valve 32, which can be selectively opened or closed in order to set the venting mass flow 82.5, the vapour compressor 40, the mass flow 82.4 of which can likewise be set via the rotational speed, the heating device 50, the power of which can be set in order to regulate the steam temperature 82.2, and the conveying system 60, which permits setting of the conveying speed and thus both of the material throughput 82.1 and of the residence time of the material to be dried in the chamber.

The variable material quantities 83 comprise the dry substance fraction 83.1 at the inlet, the material consistency 83.2, the material form 83.3 and the material-dependent sorption isotherm 83.4. As control variables 84, primarily the dry substance fraction 84.1 at the outlet and the height 84.2 (or position) of the transition layer are predetermined.

The condensator pressure 85.1 and the specific energy expenditure 85.2 (in kWh/kg of water) result as resulting quantities 85 from the operating parameters.

FIG. 7 is a block diagram of the sensor system of the plant according to the invention. The following quantities are continuously measured and supplied to the plant controller:

| sensor | measured quantity | location |
|---|---|---|
| temperature sensor 91.1 | temperature | downstream of the circulating fan 20, |
| | | upstream of the heat exchanger 30 |
| temperature sensor 91.2 | temperature | downstream of the heat exchanger 30, |
| | | upstream of the heating units 51a, 51b |
| temperature sensor 91.3a | temperature | downstream of the heating unit 51a (1^{st} |
| | | vapour flow) |
| temperature sensor 91.3b | temperature | downstream of the heating unit 51b |
| | | (2^{nd} vapour flow) |
| temperature sensor 91.4a | temperature | at the outlet of the chamber 10 for the |
| | | vapour (1^{st} vapour flow) |
| temperature sensor 91.4b | temperature | at the outlet of the chamber 10 for the |
| | | vapour (2^{nd} vapour flow) |
| temperature sensor 91.5 | temperature | upstream of the circulating fan 20 |
| temperature sensor 91.6 | temperature | upstream of the vapour compressor 40 |
| sensor | measured quantity | location |
| temperature sensor 91.7 | temperature | downstream of the vapour compressor |
| | | 40 |
| temperature sensor 91.8a | temperature | in the measuring tube 63, top |
| temperature sensor 91.8b | temperature | in the measuring tube 63, center |
| temperature sensor 91.8c | temperature | in the measuring tube 63, bottom |
| temperature sensor 91.9 | temperature | in the condenser |
| pressure sensor 92.1 | pressure | downstream of the circulating fan 20, |
| | | upstream of the heat exchanger 30 |
| pressure sensor 92.2 | pressure | downstream of the heat exchanger 30, |
| | | upstream of the heating units 51a, 51b |
| pressure sensor 92.6 | pressure | upstream of the vapour compressor 40 |
| pressure sensor 92.7 | pressure | downstream of the vapour compressor |
| | | 40 |
| pressure sensor 92.9 | pressure | in the condenser |
| oxygen sensor 93 | oxygen content | downstream of the heat exchanger 30, |
| | | upstream of the heating units 51a, 51b |

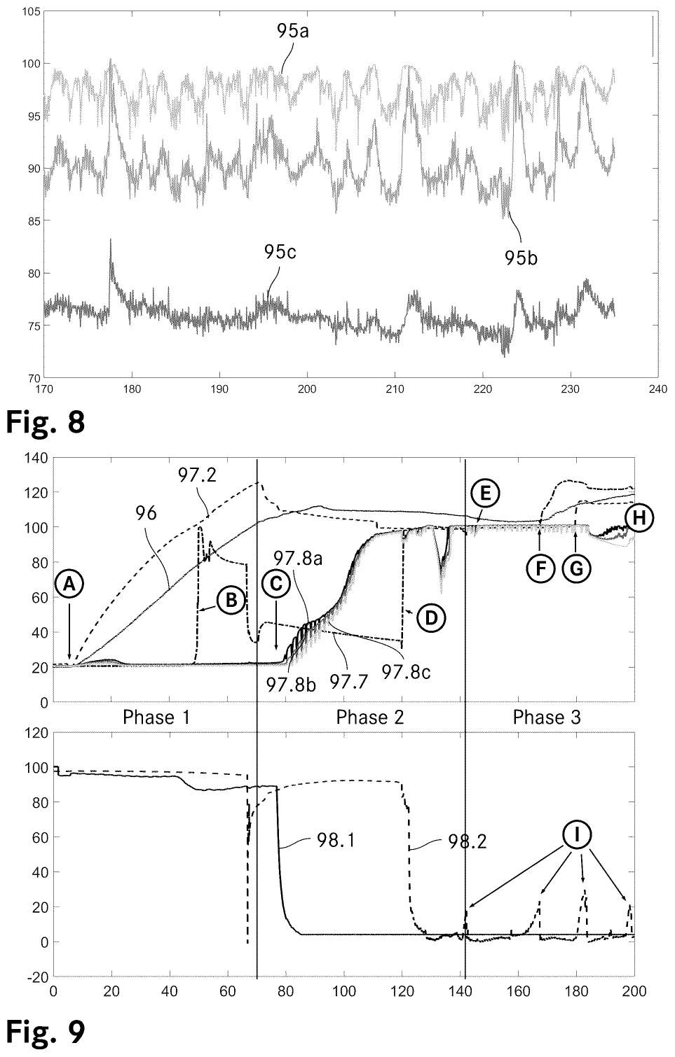

FIG. 8 shows profiles of the measured temperature at three heights in a vertical pipe next to the outlet, measured by the temperature sensors 91.8a, 91.8b, 91.8c in the measuring tube 63 (cf. FIG. 7). The uppermost temperature sensor 91.8a is arranged at a vertical distance of 50 mm from the chamber bottom. Adjacent sensors are arranged at a vertical distance of in each case 50 mm from one another. The uppermost curve 95a represents the values measured by the uppermost temperature sensor 91.8a, the middle curve 95b represents the values measured by the middle temperature sensor 91.8b, and the lowermost curve 95c represents the values measured by the lower temperature sensor 91.8c. The measurement series relate to the drying operation in which a state of equilibrium is desired by the regulation of the abovementioned control variables 82. In the present case, the temperature measured by the uppermost temperature sensor 91.8a is used as the basis for the regulation of the control variables 82, in particular of the mass flow 82.4 of the vapour compressor 40, so that the transition layer is kept at its height 84.2 by regulation. The setpoint value is 97.0° C. Alternatively, the middle temperature sensor 91.8b can be used or a quantity derived from the measured values of a plurality of sensors. If the corresponding temperature or a quantity determined from the corresponding temperatures leaves a predetermined band (for example regulation temperature±1K), the rotational speed of the vapour compressor 40 is regulated up or down during operation according to variant 1A or 1B. Advantageously, a PID control which is known per se is used for the regulation. Values of P=1, I=10 and D=0, for example, can be selected for the rotational speed regulation of the vapour compressor 40.

The starting up of the plant according to the invention is described with reference to FIG. 9, which shows profiles of the temperature (at the top, in ° C.) and of the air content (at the bottom, in %) when the plant according to the invention is started up. The starting up is divided into three phases, a heating-up phase with air (phase 1), the vapour filling (phase 2) and finally the material filling (phase 3). The chamber temperature 96 in the upper region of the chamber, the temperature 97.2 measured by the temperature sensor 91.2 downstream of the heat exchanger 30, the temperature 97.7 measured by the temperature sensor 91.7 downstream of the vapor compressor 40 and the temperatures 97.8a, 97.8b, 97.8c of the three temperature sensors 91.8a, 91.8b, 91.8c in the measuring tube 63 (with temperature generally decreasing downwards) are illustrated in the upper region. The air content 98.1 in the chamber 10 measured by means of a lambda probe and the air content 98.2 in the condenser determined indirectly on the basis of the measured pressure and the measured temperature of the steam at the condensate outlet downstream of the condenser are illustrated in the lower region. The vapour filling can be monitored accurately with these measured values, in combination with the temperature measurements.

The vapour drying is effected in a vapour atmosphere at ambient pressure, wherein the air content in the vapour atmosphere should not be more than 4%. The chamber of the plant must therefore first of all be preheated to a temperature of at least 100° C. with air and a vapour atmosphere must be created therein. This is achieved in three phases.

In a first phase, the plant is heated with hot air. For this purpose, air is circulated with the circulating fan 20 and heat is supplied in the process via the heating device 50. This phase begins at position A in FIG. 9 and lasts approximately one hour. Toward the end of this phase, the vapour compressor 40 is switched on in idling (short-circuited) (position B) in order likewise to preheat it, as a result of which greater thermal stresses and condensation in the vapour compressor 40 during the vapour filling are avoided. The phase is concluded when the chamber 10 reaches a temperature of over 100° C. The temperature 97.2 of the circulating air in the circulation duct has already far exceeded the value of 100° C. at this time, since the air is heated directly.

After the chamber temperature of 100° C. has been reached, the vapour filling begins (position C). For this purpose, the heating device 50, the vapor compressor 40 and the circulating fan 20 are switched off and steam from the steam generator 15 is conducted into the chamber 10 from above. In this case, the air, which has a lower density, is displaced downwards out of the chamber 10. This becomes apparent by the increase in the temperatures 97.8 a. c measured by the temperature sensors 91.8 a. c at the material outlet. Toward the end of this phase, the vapor compressor 40 is switched on again in order to reach operating temperature, as a result of which the temperature 97.7 briefly kinks (position D).

With regard to the air contents, the air content 98.1 in the chamber initially decreases abruptly, then the temperatures 97.8a . . . c measured by the temperature sensors 91.8a . . . c increase slowly, since the hot air is displaced downwards. When these reach 100° C., this means that the steam volume has arrived at the installation base. It has been found that the air can be displaced out of the chamber from the top downwards without problems by the lighter steam. Finally, the steam floats above the cold ambient air. Despite the openings on the underside of the chamber, a stable transition layer 66 is formed between steam and air, the so-called stratification layer (cf. FIG. 2). In the region of this layer, a temperature profile is established which extends within approximately 50 cm from ambient temperature to over 100° C. In the region of the temperature gradient from 100° C. to 65° C., the temperature gradient is typically 0.13-0.26 K/mm. The air content in the chamber 10 in this case falls to less than 4%.

As soon as the vapour atmosphere has been generated, material can be conducted into the plant (position E). During this phase, steam still has to be generated with the steam generator 15. This is necessary since steam condenses on the cold material and thus heats the latter. Since sufficient steam has not yet been generated by the drying process, it has to be provided by the steam generator 15. During this process phase, the heating device 50 and the circulating fan 20 are put into operation again. As soon as a large part of the receiving capacity of the chamber 10 has been filled with material, the vapor compressor 40 is started up further, whereby the condensator pressure rises (position F). As a result, the condensation temperature in the condenser increases, as a result of which heat can be output to the steam circuit again (position G). If the chamber 10 is completely filled with material within the scope of its receiving capacity and a sufficient water evaporation rate has been reached, the steam generator 15 can be switched off and the regular drying process begins. The air content in the chamber 10 in this case remains at less than 4%. During operation according to one of the variants 2A and 2B, the steam generator continues to run (usually with reduced power) in order to regulate the height of the transition layer.

Since, on the one hand, the target dry substance fraction of the material at the outlet depends on the relative pressure and therefore on the steam temperature (provided that the residence time is sufficiently long) and, on the other hand, heat has to be supplied continuously to the continuous process for preheating the material, the heat is supplied at high temperature before the supply of the material, while the preheating of the material on entry into the steam atmosphere is effected at lower temperature by the vapour.

During this phase, the condenser has to be deaerated further. Although the air content in the plant is very low, the residual air builds up in the condenser and has to be discharged continuously (position I). In this case, the air content on the condenser side is regulated by the controller of the air discharge valve 32 to a value of less than 15% by volume, in particular 7-10% by volume. The air content is determined on the basis of the measured values of the temperature sensor 91.9 and of the pressure sensor 92.9.

In the drying operation, the moisture of the material to be dried evaporates in the chamber 10 by supplying heat from the superheated steam. At the inlet of the chamber 10, the steam is superheated above the saturation temperature. As the material to be dried passes, the thermal energy of the steam is transferred to the material and additional water evaporates.

At the outlet of the chamber 10, the steam mass flow is increased with the water evaporated from the material. The temperature in this case is lowered depending on the dry substance content of the material or the state of the sorption isotherm and the degree of heat transfer to the material, such that the steam remains superheated.

The main portion of the circuit steam then enters the heat exchanger 30 and is superheated again by the condensation of the vapour compression steam at a higher temperature on the other side of the heat exchanger 30.

After the superheating in the heat exchanger 30, heat losses are compensated for by the heating device 50. As a result, the drying temperature and thus the desired dry substance fraction at the outlet can also be set precisely and quickly. As a rule, steam temperatures of 140-170° C. are well suited for the drying, while the material temperature, depending on the sorption isotherm, is usually 105-130° C.

After the steam has left the drying chamber, a part of the additional steam is sucked out of the circuit and compressed by the vapor compressor 40 to a pressure of approximately 2.5 to 5 bar over atmospheric pressure. According to the pressure in the condenser, the steam condenses at its saturation temperature between 130° C. and 150° C. In the process, the enthalpy of evaporation released during the condensation is returned by the heat exchanger to the steam circuit at elevated temperature.

Demineralized, sterile water of more than 100° C. leaves the system through the condensate discharge valve 31, the circuit steam being retained. Finally, the water of 100° C. can be used for preheating or instead of tap water.

During the drying process, the material to be dried or dried is continuously introduced or discharged, wherein it is in each case guided through the stratification layer and, during discharge into the ambient air, undergoes redrying on account of the lower partial pressure of the steam in the ambient air and the remaining heat in the material to be dried. If the material flow is increased, the compressed first portion supplied to the heat exchanger must be correspondingly increased. This works as long as the power of the circulating fan is sufficient to return the heat. It has been found that, within this framework, the efficiency of the process is even increased if the material flow is increased.

Within the scope of the third embodiment, when the plant is started up, the vapour atmosphere is formed mainly by the following steps:
1. air displacement by steam from the steam generator;
2. introducing material to be dried;
3. activating the vapor compressor (whereby the drying process begins);
4. After the operating pressure is reached in the heat exchanger, the steam generator continues to be operated with reduced volume flow (and regulated as described above).

The invention is not restricted to the embodiments illustrated. In particular, the dimensioning of the respective plants and the conveying systems used can be adapted to the type and the amount of the material to be dried.

The material can be introduced directly from a preceding process into the steam atmosphere. In addition, the material can be preheated before being introduced into the plant. As a result, in particular, the amount of steam available for the vapor compression is increased. If waste heat, for example from an upstream or downstream process step, is available, said waste heat can be readily supplied to the plant according to the invention, and therefore the energy demand of the heating device can be reduced.

In summary, it should be noted that the invention provides a method for operating a plant for drying material to be dried by means of superheated steam and a corresponding plant which permit high energy efficiency with simple material supply and removal.

1. A method for operating a plant for drying material to be dried by superheated steam, wherein the plant comprises:
a) a downwardly open chamber with an inlet for the material to be dried, an outlet for dried material, an inlet for superheated steam and an outlet for a vapour;
b) a conveying system for introducing the material to be dried into the chamber, transporting the material to be dried in the chamber, during drying, and discharging the dried material from the chamber;
c) a vapour compressor for compressing a first portion of the vapour recirculated from the chamber; and
d) a heat exchanger for transferring heat from the compressed first portion by condensing a volume flow of the compressed first portion;
wherein the plant is configured to be operated in such a way that
e) a vapour atmosphere is formed in an upper region of the chamber the vapour atmosphere floating on ambient air located in a lower region of the chamber, wherein a transition layer is formed between the upper region and the lower region, and
f) a height of the transition layer is kept in a predetermined range by determining a current height and, depending on the determined height,
f1) a volume flow of the compressed first portion supplied to the heat exchanger is regulated; or
f2) a volume flow of a steam generator is regulated, wherein the steam generator is arranged and configured to be operated in such a way that steam is supplied to the chamber and/or generated in the chamber.

2. The method according to claim 1, wherein the current height of the transition layer is determined on the basis of measured values of at least one temperature sensor arranged in a height range corresponding to the predetermined range.

3. The method according to claim 1 wherein a drying temperature is kept in a predetermined range by comparing the drying temperature with a setpoint value and, depending on the comparison,
g1) a volume flow of a steam generator is regulated, and such that the height of the transition layer is kept in the predetermined range by regulating the volume flow of the compressed first portion supplied to the heat exchanger; or
g2) a heating power of a heating device is regulated; or
g3) the volume flow of the compressed first portion supplied to the heat exchanger is regulated, such that the height of the transition layer is kept in the predetermined range by regulating the volume flow of the steam generator.

4. The method according to claim 1, wherein the plant comprises a pipe system between the outlet for the vapour and the inlet for the superheated steam, wherein the following is arranged in the pipe system:
h) the vapour compressor;
i) a circulating fan;
j) the heat exchanger for heating a second portion of the vapour recirculated from the chamber by transferring heat from the compressed first portion by condensing the volume flow of the compressed first portion supplied to the heat exchanger; and
k) a heating device for the steam, arranged between the heat exchanger and the inlet for the superheated steam.

5. The method according to claim 1, wherein the conveying system has a rotating hollow shaft arranged in the chamber and having a plurality of discs and forming the heat exchanger, wherein a cavity is arranged in an interior of the hollow shaft, to which cavity the volume flow of the compressed first portion of the vapour is be supplied by the vapour compressor for heating the discs.

6. The method according to claim 1, wherein the heat exchanger has a venting valve on the condenser side, and wherein an opening of the venting valve is regulated on a basis of a determined air content on the condenser side.

7. The method according to claim 6, wherein the air content on the condenser side is regulated to a value of 0-50%.

8. The method according to claim 4, wherein the following steps are carried out for forming the vapour atmosphere in the upper region of the chamber:
generating steam in a steam generator and introducing the generated steam into the chamber, wherein air located in the chamber is displaced downwards out of the chamber;
during the operation of the steam generator until an operating pressure is reached in the heat exchanger:
activating the circulating fan;
activating the heating device and/or the vapor compressor,
introducing material to be dried by means of the conveying system, and
activating the vapor compressor.

9. A plant for drying material to be dried by superheated steam, the plant comprising:
a) a downwardly open chamber with an inlet for the material to be dried, an outlet for dried material to be dried, an inlet for superheated steam and an outlet for a vapour;
b) a conveying system for introducing the material to be dried into the chamber, transporting the material to be dried in the chamber, during drying, and discharging the dried material from the chamber;
c) a vapour compressor for compressing a first portion of the vapour recirculated from the chamber;
d) a heat exchanger for transferring heat from the compressed first portion by condensing a volume flow of the compressed first portion; and
e) a controller for acquiring and processing measured values and for generating control signals;
wherein the controller is configured to be operated in such a way that
f) an atmosphere of superheated steam is formed in an upper region of the chamber, the atmosphere floating on ambient air located in a lower region of the chamber, wherein a transition layer is formed between the upper region and the lower region, and
g) a height of the transition layer is kept in a predetermined range by determining a current height and, depending on the determined height,
g1) a volume flow of the compressed first portion supplied to the heat exchanger is regulated; or
g2) a volume flow of a steam generator is regulated, wherein the steam generator is arranged and configured to be operated in such a way that steam is supplied to the chamber and/or is generated in the chamber.

10. The plant according to claim 9, wherein the plant comprises a pipe system between the outlet for the vapour and the inlet for the superheated steam, wherein the following is arranged in the pipe system:
h) the vapour compressor;
i) a circulating fan;
j) the heat exchanger for heating a second portion of the vapour recirculated from the chamber by transferring heat from the compressed first portion by condensing the volume flow of the compressed first portion supplied to the heat exchanger; and
k) a heating device for the steam, arranged between the heat exchanger and the inlet for the superheated steam.

11. The plant according to claim 10, wherein the inlet for the superheated steam is arranged on the chamber in such a way that the superheated steam in a directed vapour flow intersects a conveying path of the material to be dried in the chamber.

12. The plant according to claim 11, wherein an element for homogenizing the vapour flow is arranged on the chamber side of the inlet.

13. The plant according to claim 9, wherein the conveying system has a rotating hollow shaft arranged in the chamber and having a plurality of discs and forming the heat exchanger, wherein a cavity is arranged in an interior of the hollow shaft, to which cavity the volume flow of the compressed first portion of the vapour is supplied by the vapour compressor for heating the discs.

14. The plant according to claim 9 further comprising the steam generator.

15. The plant according to claim 14, wherein the steam generator is connected to the heat exchanger in such a way that the steam generator is configured be operated at least partially with condensate from the heat exchanger.
